(19) United States
(12) Patent Application Publication
(10) Pub. No.: US 2009/0034450 A1
(43) Pub. Date: Feb. 5, 2009

(54) Methods and Devices for Transmitting Data to a Mobile Data Processing Unit

(76) Inventor: Wilfried Urner, Munchen (DE)

Correspondence Address: MEYERTONS, HOOD, KIVLIN, KOWERT & GOETZEL, P.C., P.O. BOX 398, AUSTIN, TX, 78767-0398, US

(21) Appl. No.: 11/577,165

(22) PCT Filed: Oct. 12, 2005
(86) PCT No.: PCT/EP05/10961

§ 371 Date: Oct. 7, 2008

(30) Foreign Application Priority Data
Oct. 19, 2004 (EP) 04 024 847.8

(51) Int. Cl. H04W 4/00

(52) U.S. Cl. 370/328

(57) ABSTRACT

The invention concerns a method for transmitting data to a mobile data processing unit, the method comprising the steps of a. Receiving the data with a digital audio and/or television reception device (100), wherein the data are included in a transport stream of digital audio and/or television signals; b. extracting the data from the transport stream of digital audio and/or television signals; and c. sending electromagnetic signals by the digital audio and/or television reception device (100) to transmit the extracted data from the digital audio and/or television reception device (100) to the mobile data processing unit (200), wherein d. the extracted data are transmitted from the digital audio and/or television reception device (100) to the mobile data processing unit (200) in response to periodical requests from the mobile data processing unit (200) to the digital audio and/or television reception device (100).

### 1. TECHNICAL FIELD

The present invention relates to methods and devices for transmitting data to a mobile data processing unit.

### 2. THE PRIOR ART

Mobile data processing units such as hand held computers, PDAs, intelligent mobile telephones, etc. become more and more popular. One reason is that the multimedia capabilities of these devices are constantly increasing. For examples mobile telephones nowadays include a wide variety of functions which exceed the basic necessities of communication.

However, one difficulty encountered with such mobile data processing systems is the download of data, in particular if the size of the data is comparatively large so that a download via a standard mobile communication network is slow and expensive. For example obtaining and installing a new processing application for a mobile telephone such as a new game over the GSM network is only feasible, if the game can be compressed to a small amount of data.

Another alternative is to connect the mobile data processing unit to a personal computer, which is in turn connected to the internet. This approach allows in case of a high speed internet access of the personal computer to quickly download large amount of data and to forward it to the connected mobile data processing unit. However, a considerable technical expertise about computers, the internet, etc. is required from a user, who intends to transmit data from a provider onto the mobile data processing unit in this manner.

To overcome this overall difficulty, it is known in the prior art, for example from the WO 2004/088983, the WO 03/088027 and the WO 03/088655, to provide a set top box or the like for receiving data, which comprise a convoluted television signal and additional data. The additional data are separated from the television signal and in a wireless manner transmitted to a PDA or to a mobile telephone to become accessible to a user.

In such a system, there are two conflicting objectives. On the one hand, the provider of the additional data may want to influence the content to be displayed on the mobile unit of the user. On the other hand, the user of the mobile unit itself wants to keep control, whether and which data are to be displayed on the mobile unit, preferably in a somewhat similar manner as browsing on the internet.

It is therefore a problem of the present invention to provide an improved method for transmitting data to a mobile data processing unit from a set top box or the like, which provides both, the provider of the additional data and the user of the mobile unit with balanced possibilities to influence the data, which are actually transmitted to the mobile unit.

### 3. SUMMARY OF THE INVENTION

According to one aspect of the invention, this problem is solved by a method for transmitting data to a mobile data processing unit, comprising the following steps:
receiving the data with a digital audio and/or television reception device, wherein the data are included in a transport stream of digital audio and/or television signals;
extracting the data from the transport stream of digital audio and/or television signals; and
sending electromagnetic signals by the digital audio and/or television reception device to transmit the extracted data from the digital audio and/or television reception device to the mobile data processing unit, wherein the extracted data are transmitted from the digital audio and/or televisiori reception device (100) to the mobile data processing unit (200) in response to periodical requests from the mobile data processing unit (200) to the digital audio and/or television reception device (100).

The invention is based on the idea to use the more and more popular digital audio and/or television reception devices, also called set top boxes, not only for receiving the broadcast digital television signals, but to include into the main transport stream of broadcast-media additional data. Once the combined signal has been received, the additional data are extracted and sent as an electromagnetic signal from the set top box to the mobile data processing unit, i.e. a unit which is preferably separate and not related to the ordinary function of the digital audio and/or television reception device.

The periodical requests from the mobile data unit to the digital audio and/or television reception device provide preferably a regular possibility for the content provider to send new data to the mobile data processing unit. The new data may be data requested by the user but also data which the provider wants to be received and possibly displayed by the mobile data processing unit, such as an important message. The user, on the other hand, can also influence the overall communication, since it is preferably always the mobile station or the user itself, which initiates the communication with the digital audio and/or television reception device. Further, requests for other available data can be issued by the periodic requests or by additional asynchronous requests from the mobile data processing unit to the digital audio and/or television reception device.

Preferably, the method further comprises storing the extracted data in the digital audio and/or television reception device and presenting a message to a user about the availability of the extracted data, for example on the reception device and/or an interconnected television set. Thus, the user can control if and when the data, which are stored in the digital audio and/or television reception device, are finally transmitted onto his mobile data processing unit. For example data representing a table with all results of a soccer tournament, which has been the subject matter of a related digital television broadcast, are made available to a user for transfer onto his mobile telephone or PDA.

The transmission of the data from the digital audio and/or television reception device to the mobile data processing unit, is in one embodiment performed in response to a user input at the digital television reception device or an interconnected television. This may for example be achieved by providing one or more suitable buttons on the remote control of the digital audio and/or television reception device or the device itself. In another alternative, the final transmission to the mobile data processing unit is performed in response to the digital audio and/or television reception device receiving a signal from the mobile data processing unit. Also a combination of the two initiating events is possible.

Preferably, the periodical requests from the mobile data processing unit serve to synchronize a least a part of the data in the mobile data processing unit with a set of data stored in the digital audio and/or television reception device. Accordingly, the content provider can influence the content of the data finally transmitted to the mobile station by sending new data to the digital audio and/or television reception device with the transport stream of digital audio and/or television signals wherein these data are forwarded to the mobile data processing unit in one of the subsequent synchronizations.

In a preferred embodiment, the periodic requests of the mobile data processing unit are executed automatically and preferably without user input. Furthermore, the refresh interval between the periodical requests can preferably be changed. The value for the refiesh interval is transmitted from the digital audio and/or television reception device to the mobile data processing unit preferably together with the new data for synchronization. As a result, the content provider can easily determine, how quickly the mobile data processing unit is to be updated with new data. Furthermore, the user is not disturbed by the repeated background polling of the mobile data processing unit. Preferably, the refresh interval has a length t of 1s≦t≦10s.

This is particularly advantageous, if, as presently preferred, the content of the transport stream of digital audio and/or television signals and the content of the included data are related. This aspect of the invention is particularly valuable, since it enables the content provider in a simple manner to assure that data (e.g. example a game or a piece of music) relating to a certain broadcast is without a substantial delay made available on the mobile data processing unit. In another situation, it might be advantageous to decrease the polling frequency of the mobile data processing unit, for example to reduce the processing load and to provide more processing capacity for running a downloaded application on the mobile data processing unit.

In a preferred embodiment, the transport stream comprises digital audio and/or television signals for a plurality of channels, wherein the data extracted from the transport stream and transmitted to the mobile data processing unit depend on the channel to which the digital audio and/or television reception device is tuned. This aspect expands the basic functionality of a download of data to a mobile data processing unit via a digital audio and/or television reception device so that a full new multimedia system is created, wherein additional information, games, music or other data are made available to a user on the mobile data processing unit in addition and relation to a currently selected television program.

Preferably, the extracted data for a first channel to which the digital audio and/or television reception device is tuned are stored in a memory of the digital audio and/or television reception device. In one embodiment, these data are purged, in case of a change from the first channel to a second channel, unless the extracted data for the first channel to be transmitted to the mobile data processing unit are the same as for the second channel. As a result, the maximum amount of memory of the digital audio and/or television reception device is made available for the data of the new channel. In another embodiment the data stored in the memory are maintained in case of a change from the first channel to a second channel. This embodiment allows the data sent to the mobile data processing unit to more quickly follow a further change back to the first channel.

According to a further aspect of the present invention, a method of transmitting data to a mobile data processing unit is provided comprising the steps of
including the data to be transmitted into a transport stream of digital audio and/or television signals to be broadcasted;
broadcasting the transport stream of digital audio and/or television signals with the included data in a digital format adapted for a digital audio and/or television reception device to receive the digital audio and/or television signals, to extract the included data and to transmit them to the mobile data processing unit, wherein
the included data are adapted to be transmitted in response to periodical requests from the mobile data processing unit to the digital audio and/or television reception device.

The sender of the digital television signals therefore emits a convoluted signal comprising both, the standard digital television signals to be broadcast and the additional signals for the final transmission, i.e. download, onto the mobile data processing unit. According to this aspect of the invention, the format of the convoluted signal is specifically adapted for the digital audio and/or television reception device to extract the included data from the main stream of signals so that the user can watch digital television and in addition obtain the additional data for his mobile data processing unit in response to periodical requests from the mobile data processing unit to the digital audio and/or television reception device. Preferably, the included data cause a change of the refresh interval between the periodical requests of the mobile data processing unit.

In one embodiment, the first and or the second method steps are performed in response to a provider of the data receiving a signal from the digital audio and/or television reception device and/or the mobile data processing unit. Such an advanced embodiment allows the user to interactively influence, whether additional data are transmitted to one or more digital audio and/or television reception devices for subsequent download on one or more mobile data processing units.

According to a still further aspect, the present invention relates to a digital audio and/or television reception device comprising a first reception unit receiving a transport stream of digital audio and/or television signals for display on a television and/or radio system, the transport stream of digital audio and/or television signals including additional data. The digital audio and/or television reception device further comprises an extraction unit extracting the additional data from the transport stream of digital signals, a transmission unit transmitting the extracted additional data to an external mobile data processing unit, wherein the digital audio and/or television reception device further comprises a second receiving unit adapted to receive periodic requests from the mobile data processing unit to initiate the transmission of the extracted additional data.

Finally, the present invention relates to a mobile data processing unit comprising a first transceiver unit for communication with a mobile telephone network, a second transceiver unit for communicating with a digital audio and/or television reception device, and control means with instructions for the second transceiver to periodically transmit a request to the digital audio and/or television reception device, which initiates the transmission of additional data, which are received by the digital audio and/or television reception device together with digital audio and/or television signals, to the second transceiver of the mobile data processing unit.

Further modifications of the claimed methods and the claimed devices are the subject matter of further dependent claims.

### 4. SHORT DESCRIPTION OF THE DRAWINGS

In the following detailed description presently preferred embodiments of the invention are described with reference to the drawings which show:

FIG. 1: a schematic view of the various components of a digital television reception device to be used in the context of the present invention;

FIG. 2: a schematic view of the various components of a mobile data processing unit to be used in the context of the present invention;

FIG. 3: a more detailed overview of the various elements of the present invention in a presently preferred embodiment;

FIG. 4: an overview of the stack of communication layers used for the communication between the STB and the mobile device in the embodiment of FIG. 3; and

FIG. 5: an overview of the main commands for the communication between the mobile device and the STB in the embodiment of FIG. 3.

### 5. DETAILED DESCRIPTION OF PREFERRED EMBODIMENTS

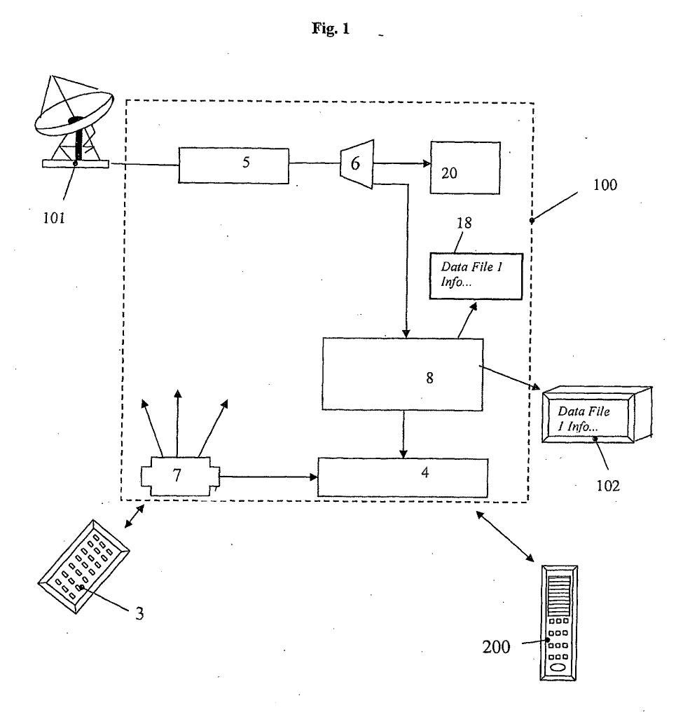

In the following the methods and devices according to the present invention are described with reference to a set top box 100 capable to receive digital television or radio signals. The arrangement of all of the functional units of the set top box 100 in a single electronic device as indicated by the dashed box in FIG. 1 is not essential. One or more components of the set top box 100 described in the following description can be realized in additional devices, which are suitably connected to the other functional units of the set top box 100. Further, whereas in the following description reference is made to a set top box 100 as a device connected to a standard television set 102, the invention can—although presently less preferred—also be realized by means of a card with suitable electronics for the reception of broadcast digital television or radio signal signals, such as a PC-card to be used in a personal computer. Furthermore, it is noted that the term set top box comprises in the context of the present application not only devices for receiving digital television signals but also devices, which in addition or alternatively are adapted to receive digital radio programs. Finally, the set top box does not necessarily have to be separate device. It can also be integrated into another device, such as a television.

FIG. 1 presents an overview of the set top box 100. A broadcast signal, carrying in the data transport stream among the digital television signals an additional data set defining e.g. a special application for a mobile data processing unit 200 is received by an antenna 101. Instead of a satellite signal received by the antenna 101, the transport stream can also be received as a terrestrial digital TV program or via a cable (not shown). The provider (not shown) of the digital television signal has modulated the additional data set onto the standard stream of digital television data, for example by including data packets with a specific header allowing the set top box to extract the additional data set during the further steps explained below. All kinds of convolution techniques for the digital television signals and the additional set of data are conceivable, including an additional compression of the convoluted stream to maximize the bandwidth for the data transmission to the set top box 100.

In one embodiment (not shown), the transmission of the additional data set is performed in response to the provider receiving a signal from one or more users. Such an initiating signal may be received via a standard return line from the set top box 100 to the provider using a modem connection or the like, or the mobile data processing unit 200, for example a mobile telephone, communicates a request for additional data to the provider via its communication network, for example a GSM, a GPRS or a UMTS network.

The content of the additional data set is preferably related to the content of the broadcast signal. One example is additional information relating to a live event, such as a soccer tournament. The additional data could then comprise a wide variety of data content, such as further statistics about the ongoing tournament or even a related computer game to be played by the user on the mobile data processing unit 200. Another application is the download of sound files relating to a movie presently broadcast in a channel of the digital television signals. The user can thus store the sound track of the movie on this mobile data processing unit, such as a MP-3 player to listen to it later again. These are only two examples and it is apparent to the person skilled in the art that many useful applications are conceivable wherein the content of the additional data complements in a meaningful manner the content of the digital television signals.

The set top box 100 can be operated using a remote control 3, which interacts with a remote control sensor 7 to issue commands to one or more central processing units (not shown) of the set top box 100. Alternatively or additionally, the set top box 100 may also comprise input means such as push buttons or switches (not shown in FIG. 1). A display 18 of the set top box 100 allows to display messages to a user.

In a front end unit 5 of the set top box 100, the broadcast signal provided from the antenna 101 is demodulated. Subsequently, the additional data set is filtered out by means of a data filter 6. The digital television signals are further processed by the set top box 100 in a standard manner. In FIG. 1 this is only schematically indicated by the unit 20, which represents the standard audio and/or video processing of the set top box 100.

It is to be noted that there are many ways to implement the data filter 6, for example by hardware or by software. A software solution may be more flexible, to adapt the set top box 100 to new data formats, whereas a hardware solution may be faster. Also combinations of the two alternatives are possible. Further, the function of the initial demodulation of the received signal, including both the digital television signals and the additional data set, and the subsequent filtering can be combined in a single unit or the data set could even be filtered out from the received signal, before the television signal is demodulated.

After the additional data set has been filtered out, it is stored in a memory 8 and remains in a “wait” status. The memory can be realized in many different ways, for example as a RAM or even as a permanent memory such as a disk drive or a flash ROM. The memory 8 can also be simply a certain range of the ordinary memory range of the set top box 100. The additional data set remains in the memory 8 until it is downloaded onto the mobile data processing unit 200 as described below or erased in response to a user command. Further it is also possible to include a timer function in the set top box 100 so that an additional data set, which has not been downloaded within a predetermined amount of time, will be automatically erased or overwritten by new data. In a simpler embodiment, the extracted data is not stored within the set top box but immediately sent to the mobile data processing unit as described below.

In order to inform the user about the availability of additional data for download onto the mobile data processing unit 200, the set top box 100 can present a message either on its own display 18, as schematically indicated in FIG. 1 (“Data File 1 Info . . . ”) or the message will be presented on the screen on the connected television set 102. Also a combination of the two display functions is possible, wherein for example the display 18 informs only about the general availability of an additional set of data and wherein the display of the television set 102 present upon user request additional information about the data set, such as content, size and possibly costs related to the download of the data onto the mobile data processing unit 200.

The actual transfer of the stored set of additional data from the set top box 100 to the mobile data processing unit 200 can be triggered by various means. One option is a user input at the set top box 100, either directly of via the remote control 3. In this case the set top box 100 will try to establish a communication link, preferably a wireless link, to the mobile data processing unit 200 using its transceiver 4. Such a transceiver 4 can for example be realized as an infrared port, which communicates with a corresponding infrared port of the unit 200 (not shown in FIG. 1). In another embodiment RF-signals are used, following for example the Bluetooth protocol (see below). Preferably, the set top box 100 comprises more than one possibility for a wireless communication so that it can flexibly adapt to different types of mobile data processing units 200. Finally, it is also possible to transfer the electromagnetic signals containing the data onto the mobile data processing unit using a connection via a cable (not shown).

Alternatively, the transfer of the stored data onto the mobile processing unit 200 could also be triggered by the unit 200. In this alternative embodiment, the user would simply position the unit 200 within the transmission range of the transmitter 4 and send a corresponding request to the set top box 100, which would then initiate the download of the stored data. Clearly also a combination is possible, wherein one side, the set top box 100 or the mobile data processing unit 200, sends at first a request, which is then confirmed by a user input at the other device to start the transmission.

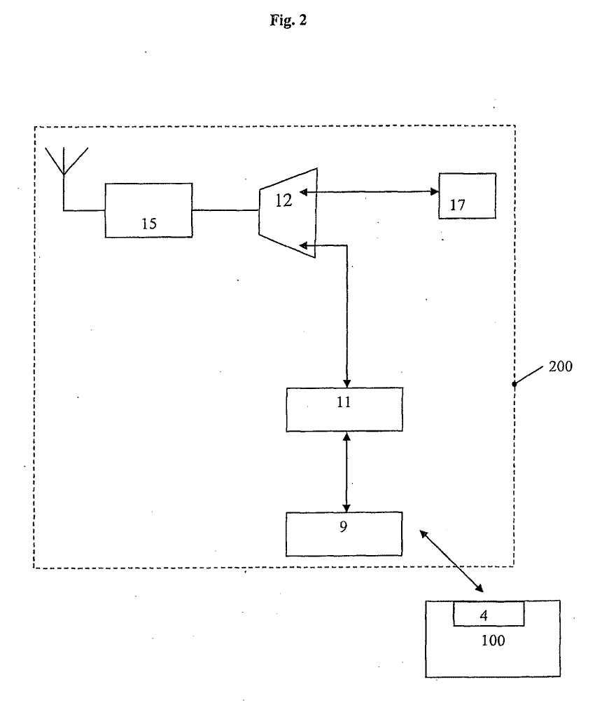

FIG. 2 shows schematically a mobile data processing unit 200 in accordance with aspects of the present invention. Generally, there are many mobile devices, which may be used in conjunction with the present invention, such as PDAs, hand held computers, notebooks, MPEG-3 players. However, since cellular telephones are most common and allow not only to process the receive data but also to communicate signals relating to the processed data over a communication network (such as a GSM-network or a CDMA-network), the following description will be focused on the modifications of such a device for cooperation with the set top box 100 described above.

The cellular telephone comprises preferably two transceiving units, the first 15 for the standard communication network, such as a GSM-, a GPRS or a CDMA (UMTS) network, the other 9 for communicating with the transceiver 4 of the set top box 100. The second transceiver 9 may be provided as an infrared port or/and as a Bluetooth transceiver for RF-signals. In a preferred embodiment the cellular telephone 200 comprises a processor and a memory with instructions so that the transceiver 4 will send a request to the set top box 100 for transmission of available data. The request from the cellular telephone can be sent in response to a user input or automatically, when the cellular telephone is switched on. In the latter case, the download of the additional data stored in the set top box will automatically start, when the cellular telephone 200 is sufficiently close to the transceiver 4 of the set top box 100 and turned on. This is significantly easier for a user than downloading data from the internet with a personal computer and subsequently transferring it onto the cellular telephone for later use. The downloaded data is stored in the cellular telephone 200 in a memory 11, where it is available for further processing.

According to a more advanced aspect of the present invention, the downloaded data may comprise interactive features, which require that the user sends information from the cellular telephone 200 back to the provider (not shown) or another user of the digital television signals. For example an interactive game may be played by many users, wherein general information and/or results are broadcast on the television 102 and wherein each user plays with his cellular telephone 200 over the cellular network.

Since the interactive game (or the like) itself is created by the provider as additional data included in the digital television signals, the overall setup for such a game or a similar event is very easy for the user and does not require particular technical skills. Other functional units of the cellular telephone, such as a camera or a microphone may be involved in the interactive processing of the data received from the set top box 100.

The connection to the cellular network is reflected in FIG. 2, by the data filter 12 of the cellular telephone 200. Under the control of a processor and an operating system etc. of the cellular telephone (not shown) data resulting from processing the data received over the transceiver 9 can be sent out via the first transceiver 15 and an attached antenna. The data filter 12 assures that the transmission of this data does not interfere with other voice and data services 17 of the cellular telephone.

In the following parts of the present specification, a currently preferred embodiment of the invention is further described. In addition, the annexed two specifications of the “Blucom” Receiver Requirements and of the “Blucom” Browser Application explain all aspects of a presently preferred embodiment of a set top box 100 and of a browser application running on the mobile device 200 or another type of mobile data processing unit used in the context of the present invention. However, it is to be noted that a practical embodiment does not need to realize all of the features which are described below or in the attached specifications. On the contrary, some embodiments will only use individual or a few aspects of the system as described below. In particular, most of the described features can be implemented independently from other features of the system.

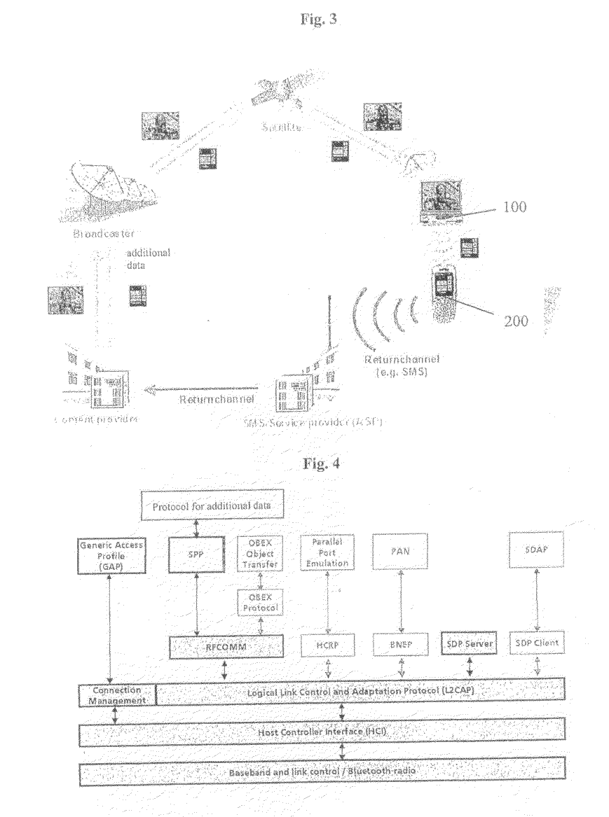

FIG. 3 presents an overview of the architecture. As can be seen, a content provider creates content of additional data by using an appropriate authoring system. In addition, a broadcaster is shown, which is in charge of formatting the additional data content according to the data carousel format used, and sends the convoluted data to a satellite. Alternatively, the convoluted data may be broadcast using a cable network or terrestrial broadcasting.

The transport stream of convoluted digital data comprising the television signal and the additional data is received by a digital receiver or set top box 100. The digital receiver or set top box (STB) acts as a content server towards any client device such as the mobile phone 200. The additional data is parsed from one or more data carousels, which are canied in the transport stream in a similar manner as data components of any MPEG program. The STB stores the complete payload of all additional data carousels of the appropriate version (see below) in a cache, which is allocated in the STB's RAM. The cache of the STB can be regarded as a shared memory resource which is filled with data from the satellite. Data is requested out of the cache by a data server component, which is dedicated to handle client requests for the additional data, for example from the mobile phone 200.

The directory structure inside the cache is according to the path and filename information obtained from the headers as contained in the transport stream. This structure is used as a reference for client requests. In addition, the data carousel comprises further information, such as control parameters. Updates of the data carousel for the additional data, i.e. new versions, are detected by a change of a suitable identification.

More in detail, the cache of the STB is managed as follows: As soon as the STB detects a valid component of additional data on the actually tuned MPEG program, the STB immediately starts capturing the additional data and writes it to the cache. The cache is purged upon a change of the actual tuned service to another service which carries additional data and filled with the additional data of the then tuned service. However, if the identification of the new service matches the identification of the previously tuned service, the STB maintains the cache in order to allow for a better performance in case data is shared between services.

If the RAM space reserved for the cache does not need to be completely allocated to store the additional data of the new service, the STB may keep the previous data in order to speed up access if the STB is tuned back to the previous service. If the new service does not provide additional data, previously downloaded additional data is maintained in the cache in order to allow for a fast access in case the user switches back to the previously tuned service.

Control parameters relating to the additional data of a certain service or channel are deleted immediately upon a service change, regardless whether the new service carries any additional data or not. This provision ensures that only the additional data of any given service is available. However, if the identification of the new service matches the identification of the previously tuned service, the STB maintains the control parameters in order to allow for a better performance in the case where additional data is shared between services.

For transmitting control parameters relating to the additional data, a control file is preferably included in the transport stream to the STB. The purpose of the control file is to specify the receiver's reaction upon a client's request for the additional data. Unlike the actual data files with the content, which will be stored in the receiver's file system without any prior interpretation, the STB needs to parse the content of the control file and store the control parameters iumediately after reception of the control file.

In the carousel sent from the satellite, the control file is identified by the presence of a control file descriptor in the respective data header. As soon as the STB detects a new control file in the received data carousel, it updates the control file data in the receiver's RAM. Upon the next client request, the STB reacts according to the rules determined by the new control file. In the preferred embodiment, the control file is based on the XML file format.

The communication between the STB 100 and the mobile device 200 (phone, PDA or the like) depends on the hardware and on the interface protocol. In the following, preferred embodiments thereof are briefly discussed.

As mentioned above, the STB 100 comprises preferably an interface capable to communicate with the mobile device 200 using the Bluetooth standard. Preferably, the performance of the interface ensures that under the conditions indicated below, the reaction time upon client requests does not exceed a defined limit. The conditions are as follows:
Only one client is connected to the STB.
Bluetooth data rate 500 kb/s net.
Measurement point is the Bluetooth radio layer.
The requested file is already present in the STB's cache.

Upon a client request for a 10 kB file, the STB completes the delivery of the whole file within 250 ms after the issuing of the client request.

To meet the above requirement, preferred hardware for the STB comprises an amount of at least 16 MB to be assigned to the above discussed cache. For the communication with the mobile device 200, the STB preferably comprises a power class 2 Bluetooth radio device, which provides a stable connection over a distance of at least 10 meters from a front panel of the STB.

The Interface Protocol between STB 100 and Mobile Device 200 is preferably also based on the XML file format. In order to keep the amount of protocol data as small as possible, it is recommended to use the XML short-form for building the XML protocol. The low level communication is preferably based on the Bluetooth wireless technology. FIG. 4 shows the arrangement of the described protocol of the service to access additional data on top of the Bluetooth protocol stack.

Accordingly, to set up a connection between the mobile device 200 and the STB, the Bluetooth device (not shown) on the mobile phone needs to be enabled and ready for connecting a remote Bluetooth device before a communication software, the “browser”, is started. After launching the browser, it verifies whether the Bluetooth device of the mobile device 200 is enabled and ready. If there is no Bluetooth device available or if it is not switched on, the browser will advice the user how to switch on the Bluetooth device.

Bluetooth device and service discovery are initiated by the browser application running on the mobile device 200. For finding the right device, the browser performs a service inquiry on each discovered device in order to assure that the mobile device only connects to the corresponding application. When more than one device is discovered that offers a service to access additional data on a STB, a list of the Bluetooth specific, user-friendly device names is presented to the user for selection.

After the right device (STB) was discovered or selected by the user, the browser tries to set up a connection to it. Depending on the configuration on the STB side, it might be necessary to enter an authentication id (PIN) to get connected. After successfully connecting to the STB, the remote device has to be added to the trusted device list if the device supports correct list management in order to avoid recurring pin requests for subsequent connections to that device.

After successful device and service discovery, the browser preferably sends an initial request to the STB in order to get a copyright string compared with its counterpart on the STB side. In case of a negative response or even a missing response within a configured timeout period, the browser displays a message denoting that the STB is not authorized for the service to access additional data. The copyright string is a static text string that has no further meaning. It is required for legal reasons only and can be defined by the system provider.

After successful connection the browser has to display a first page. Therefore, browser has to execute a Sync-Command, which is further described below to get synchronised to the current service provided by the STB. Provided that there is a channel with additional data available, the browser receives an URL for which the content has to be retrieved and displayed.

In the following the content retrieval of the browser is further described: The content of the additional data may be prepared by different content providers. The providers use pages to logically structure the content. The browser displays a single page at a time. Each page is attached to a specific context. The context id is delivered for each page retrieved from server. The context is significant for page requests and the maintenance of contextual variables.

The content is pulled from the STB 100 by the mobile device 200. There are two ways how content can be pulled from the STB.

For an automatic page request, the browser automatically requests a new page from the server according to a refresh interval, which is determined in the protocol. This refresh interval may change after each subsequent page or content request. All automatic page requests are executed silently: Since the user did not trigger the retrieval, no message may be displayed if the request, retrieval or processing of those pages fails.

The automatic page request enables also frequent updates of the content by the content provider. Two types of update are distinguished:
The provider determines a new, different page, which must be displayed by the browser as soon as possible for example to adapt the displayed content to the presently running television program of a channel.
The provider generates an update of the page currently displayed by browser, which is displayed instead of old (out-of-date) page.

Accordingly, which page to be displayed next is completely controlled by the STB. The browser requests and displays each new page indicated by the STB except page name, page version and context have not changed relating to the currently displayed page.

On the other hand, since the STB does not deliver new pages unless the browser requests them, the browser must periodically poll the server and ask for page updates. Preferably, the browser is capable to handle lookup intervals of 1 second or less. Preferably, the refresh interval is a dynamic value

In addition to automatic page request, there is preferably the option of a manual page request. The user may trigger a page request asynchronously by selecting a link inside the page currently displayed. The browser tries to retrieve all contents needed to display that page. All manual page requests are executed actively, i.e. the user gets a readable, visual feedback about the browser activity. If the requested page cannot be displayed due to an error, an error message is displayed.

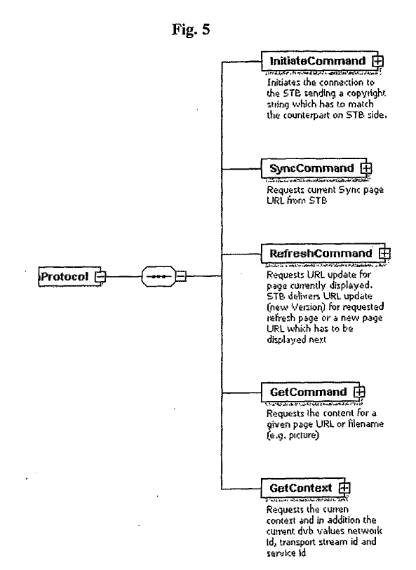

FIG. 5 presents an overview of five different commands, which are used for the communication between the mobile device 200 and the STB 100.

The Initiate Command is a precondition for all further commands. If the STB is not able to answer an Initiate Command with OK, all following requests (except further Initiate Commands) will be answered with the return code FAILED.

Using the Sync Command the browser asks the STB for the sync page URL that is currently valid, i.e. data stored in the STB, which is to be synchronized with the mobile device. Beside the URL of the current sync page, the response delivers information about the present context and the new refresh interval. A return code informs about the response status. Once the response was successfully processed and the further conditions are fulfilled, the browser acquires the contents for the new page URL in order to display the new page.

With the Refresh Command the browser sends the URLs and the file versions for the page currently shown on display and for the present sync page, which may be different from the present one. Once the response to the Refresh Command was successfully processed and further conditions are fulfilled, the browser acquires the contents for the new page URL delivered in order to display the new page. A return code informs about the response status.

The new page might be either an update for the page currently displayed or a new sync page which is immediately displayed, as described above. Additionally, the response code delivers information about the present context, the new refresh interval and above that a flag, which determines if the URL supplied is a sync page or not. In case that the new page is signalled as a sync page, the browser saves that URL and version as its current sync page.

The further command Get Command serve to ask the STB for the content of a certain page, whereas the fifth command Get Context serves to obtain relevant parameters such as an identification of the present service to which the STB is presently tuned.

Further aspects of the presently preferred embodiment of the invention are described in the two annexes.

### Annexes:

### “Blucom” Receiver Requirements Version 1.53a

Functional Specification “Blucom” Browser Application Version 1.6

1-26. (canceled)

27. A method for transmitting data to a mobile data processing unit, the method comprising the following steps:
a. receiving the data with a digital audio and/or television reception device, wherein the data are included in a transport stream of digital audio and/or television signals;
b. extracting the data from the transport stream of digital audio and/or television signals; and
c. sending electromagnetic signals by the digital audio and/or television reception device to transmit the extracted data from the digital audio and/or television reception device to the mobile data processing unit, wherein the extracted data are transmitted from the digital audio and/or television reception device to the mobile data processing unit in response to requests from the mobile data processing unit to the digital audio and/or television reception device, characterized in that
d. the requests are periodical synchronization requests for the extracted data and the refresh interval between the periodical synchronization requests for the extracted data is changeable by transmitting a value for the refresh interval from the digital audio and/or television reception device to the mobile data processing unit.

28. The method according to claim 27, wherein the periodical synchronization requests from the mobile data processing unit serve to synchronize a least a part of the data in the mobile data processing unit with a set of new data stored in the digital audio and/or television reception device.

29. The method according to claim 28, wherein the periodical synchronization requests are executed automatically.

30. The method according to claim 29, wherein the value for the refresh interval is transmitted together with the new data for synchronization.

31. The method according to claim 27, wherein the mobile data processing unit can in response to a user input asynchronously issue manual requests for data to be transmitted from the digital audio and/or television reception device.

32. The method according to claim 27, wherein the content of the transport stream of digital audio and/or television signals and the content of the included data are related.

33. The method according to claim 32, wherein the transport stream comprises digital audio and/or television signals for a plurality of channels and wherein the data extracted from the transport stream and transmitted to the mobile data processing unit depend on the channel to which the digital audio and/or television reception device is tuned.

34. The method of claim 33, wherein the extracted data for a first channel to which the digital audio and/or television reception device is tuned are stored in a memory of the digital audio and/or television reception device.

35. The method of claim 34, wherein the data stored in the memory are purged, in case of a change from the first channel to a second channel, unless the extracted data for the first channel to be transmitted to the mobile data processing unit are the same as for the second channel.

36. The method of claim 34, wherein the data stored in the memory are maintained in case of a change from the first channel to a second channel.

37. The method of claim 27, wherein the refresh interval has a length t of 1s≦t≦10s.

38. A method of transmitting data to a mobile data processing unit, comprising the following steps:
a. including the data to be transmitted into a transport stream of digital audio and/or television signals to be broadcasted;
b. broadcasting the transport stream of digital audio and/or television signals with the included data in a digital format adapted for a digital audio and/or television reception device to receive the digital audio and/or television signals, to extract the included data and to transmit them to the mobile data processing unit, wherein the included data are adapted to be transmitted in response to requests from the mobile data processing unit to the digital audio and/or television reception device, characterized in that
c. the requests are periodical synchronization requests for the included data, and the included data cause a change of the refresh interval between the periodical synchronization requests of the mobile data processing unit for the included data.

39. The method of claim 38, wherein the method steps a. and/or b. are performed in response to a provider of the data receiving a signal from the digital audio and/or television reception device and/or the mobile data processing unit.

40. The method of claim 38, wherein the refresh interval has a length t of 1s≦t≦10s.

41. A digital audio and/or television reception device comprising:
a. a first reception unit receiving a transport stream of digital audio and/or television signals for display on a television and/or radio system, the transport stream of digital audio and/or television signals including additional data;
b. an extraction unit extracting the additional data from the transport stream of digital signals;
c. a transmission unit transmitting the extracted additional data to an external mobile data processing unit,
d. a second receiving unit adapted to receive periodical synchronization requests for the extracted additional data from the mobile data processing unit to initiate the transmission of the extracted additional data, characterized in that
e. the digital audio and/or television reception device is further adapted to change the refresh interval between the periodical synchronization requests for the extracted additional data from the mobile data processing unit.

42. Digital audio and/or television reception device according to claim 41, further comprising a memory adapted to synchronize the data in the mobile data processing unit with new data in response to the periodical synchronization requests from the mobile data processing unit.

43. Digital audio and/or television reception device according to claim 42, further adapted to change the refresh interval together with transmitting the new data for synchronization.

44. Digital audio and/or television reception device according to claim 41, wherein the transport stream comprises digital audio and/or television signals for a plurality of channels and wherein the extracted data which are to be transmitted to the mobile data processing unit for a first channel to which the digital audio and/or television reception device is tuned, are stored in a memory of the digital audio and/or television reception device.

45. Digital audio and/or television reception device according to claim 44, further adapted to purge the data stored in the memory, in case of a change from the first channel to a second channel, unless the extracted data for the first channel to be transmitted to the mobile data processing unit are the same as for the second channel.

46. Digital audio and/or television reception device according to claim 44, further adapted to maintain the data stored in the memory, in case of a change from the first channel to a second channel.

47. A mobile data processing unit comprising:
a. a first transceiver unit for communication with a mobile telephone network;
b. a second transceiver unit for communicating with a digital audio and/or television reception device;
c. control means with instructions for the second transceiver to transmit a request to the digital audio and/or television reception device, which initiates the transmission of additional data, which are received by the digital audio and/or television reception device together with digital audio and/or television signals, to the second transceiver of the mobile data processing unit, characterized in that
d. the request is a synchronization request for the additional data and the control means are adapted to periodically transmit the request; and
e. the mobile data processing unit is further adapted to receive a value for the refresh interval between subsequent periodical synchronization requests for the additional data.

48. Mobile data processing unit according to claim 47, wherein the periodical synchronization requests from the mobile data processing unit serve to synchronize the data in the mobile data processing unit with new data stored in the digital audio and/or television reception device.

49. Mobile data processing unit according to claim 48, further adapted to receive the value for the refresh interval transmitted from the digital audio and/or television reception device as part of the synchronization data.

50. Mobile data processing unit according to claim 48, wherein the control means comprises instructions to asynchronously issue additional requests for further data in response to a user input.

51. Mobile data processing unit according to claim 47, wherein the control means further comprise instructions for the first transceiver unit to transmit a request for the additional data to a provider of the digital audio and/or television signals.
